(19) United States
(12) Patent Application Publication
(10) Pub. No.: US 2007/0250828 A1
(43) Pub. Date: Oct. 25, 2007

(54) PORTABLE LIBRARIES

(76) Inventors: Ariel D. Tseitlin, Sunnyvale, CA (US); Daniel Kearns, Moss Beach, CA (US); Gilberto Arnaiz, Redwood City, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/426,256

(22) Filed: Jun. 23, 2006

Related U.S. Application Data
(60) Provisional application No. 60/693,550, filed on Nov. 16, 2005.

(51) Int. Cl. G06F 9/44

(52) U.S. Cl. 717/163

(57) ABSTRACT

A method is provided. The method designates an intersection library that includes an intersection of a first set of pre-constructed code that utilizes a first set of syntax language from a first platform and a second set of pre-constructed code that utilizes a second set of syntax language from a second platform. Further, the method composes platform independent code for an application service for an enterprise module. The platform independent code is compiled and linked with the intersection library. In addition, the method designates a portable library that includes a third set of pre-constructed code that utilizes a third set of syntax language from a third platform and a fourth set of pre-constructed code that utilizes a fourth set of syntax language from a fourth platform. Further, the third set of pre-constructed code and the fourth set of pre-constructed code are composed in order to accomplish the same task. The portable library is compiled with platform dependent code for a core service for the enterprise module.

### RELATED APPLICATION

This application claims the benefit of and priority to U.S. Provisional Application Ser. No. 60/693,550, filed Jun. 24, 2005, the contents of which are incorporated by reference herein in its entirety.

### BACKGROUND

1. Field

A method and system are disclosed which generally relate to computer application environments.

2. General Background

Computer systems form the backbone of modern business. Computer systems are used in virtually every step of a business chain. For example, computer systems are used to purchase source materials, track production, monitor inventory levels, monitor quality, set pricing, maintain customer relationships, provide accounting services, maintain a payroll, provide employee benefits, track inbound/outbound shipments, track customer satisfaction or complaints, and perform countless other tasks to run a business.

A number of enterprise software applications have been created to allow a business to perform many of these business support functions with a single integrated software application. These enterprise software applications have provided the businesses that employ these applications with a competitive advantage. However, such enterprise software applications tend to be expansive applications that require significant computer resources to run and knowledgeable technicians to maintain. Furthermore, enterprise software applications tend to be expensive programs to purchase or lease. Thus, enterprise software applications have mainly been used only by very large corporations that are able to afford such infrastructure investments and continue to pay for their continued use.

Even very large corporations can have some difficulties with large enterprise software applications. For example, a large corporation may already have a legacy software application that the large corporation wishes to continue using. Thus, integrating the legacy software application with a new enterprise software application can be difficult and require very skilled application integrators.

Furthermore, corporations in different business segments often have very different needs from their enterprise software applications. Therefore, a corporation using with a “one-size-fits-all” enterprise software application may find that the “one-size-fits-all” enterprise software includes many unnecessary features. These unnecessary features needlessly cost the corporation money and consume valuable computer resources. The enterprise software application may also be missing a number of desired industry-specific features for each different corporation. These corporations must develop these missing features internally or find another software application that provides the needed features. If an additional software application that provides the missing features is located, then the corporation must integrate that additional application with the enterprise software application.

Due to these difficulties with large enterprise software applications, it would be desirable to fine a way to make such enterprise software applications more flexible. Specifically, it would be desirable to allow small businesses to be able to afford some of the features provided by enterprise software applications. Similarly, it would be desirable to allow large corporations to easily select and install only the needed features. And finally, it would be desirable to have an ability to easily integrate the enterprise software application with other customized applications.

### SUMMARY

In one aspect of the disclosure, a method is provided. The method designates an intersection library that includes an intersection of a first set of pre-constructed code that utilizes a first set of syntax language from a first platform and a second set of pre-constructed code that utilizes a second set of syntax language from a second platform. Further, the method composes platform independent code for an application service for an enterprise module. The platform independent code is compiled and linked with the intersection library. In addition, the method designates a portable library that includes a third set of pre-constructed code that utilizes a third set of syntax language from a third platform and a fourth set of pre-constructed code that utilizes a fourth set of syntax language from a fourth platform. Further, the third set of pre-constructed code and the fourth set of pre-constructed code are composed in order to accomplish the same task. The portable library is compiled with platform dependent code for a core service for the enterprise module.

In another aspect of the disclosure, a machine readable medium has stored thereon a set of instructions which when executed perform a method. The method designates an intersection library that includes an intersection of a first set of pre-constructed code that utilizes a first set of syntax language from a first platform and a second set of pre-constructed code that utilizes a second set of syntax language from a second platform. Further, the method composes platform independent code for an application service for an enterprise module. The platform independent code is compiled and linked with the intersection library. In addition, the method designates a portable library that includes a third set of pre-constructed code that utilizes the first set of syntax language from the first platform and a fourth set of pre-constructed code that utilizes the second set of syntax language from the second platform. Further, the third set of pre-constructed code and the fourth set of pre-constructed code are composed in order to accomplish the same task. The portable library is compiled with platform dependent code for a core service for the enterprise module.

In yet another aspect of the disclosure, a system is disclosed. The system has a unit that creates a portability tree that includes a portable region and a non-portable region. Further, the system has a unit that classifies a plurality of platforms according to positions in the portable region and the non-portable region of the portability tree. In addition, the system has a unit that designates an intersection library that includes an intersection of a first set of pre-constructed code that utilizes a first set of syntax language from a first platform and a second set of pre-constructed code that utilizes a second set of syntax language from a second platform. Further, the system has a unit that composes platform independent code for an application service for an enterprise module. The platform independent code is compiled and linked with the intersection library. In addition, the system has a unit that designates a portable library that includes a third set of pre-constructed code that utilizes a third set of syntax language from a third platform and a fourth set of pre-constructed code that utilizes a fourth set of syntax language from a fourth platform. The third set of pre-constructed code and the fourth set of pre-constructed code are composed in order to accomplish the same task. Further, the portable library is compiled with platform dependent code for a core service for the enterprise module. In addition, the third platform and the fourth platform are positioned in the non-portable region of the portability tree.

### BRIEF DESCRIPTION OF DRAWINGS

The above-mentioned features and objects of the present disclosure will become more apparent with reference to the following description taken in conjunction with the accompanying drawings wherein like reference numerals denote like elements and in which:

FIG. 1 illustrates infrastructure utilized in a large and complex application, such as an enterprise application.

FIG. 2 illustrates an on-line or hosted infrastructure that can be utilized to provide an enterprise application over the Internet.

FIG. 3 illustrates an enterprise module assembly system that allows a customer to both host the enterprise application software locally and only purchase the particular modules corresponding to the services that the customer actually needs.

FIG. 4 illustrates a process of enhancing a computer system.

FIG. 5 illustrates an expanded view of the customer site, as seen in FIG. 3, for which the customer can implement the selected enterprise modules.

FIG. 6 illustrates an enterprise module construction system.

FIG. 7 illustrates a process in which the enterprise module can be generated.

FIG. 8 illustrates a portability tree that can be utilized to classify a set of code as portable and another set of code as non-portable.

FIG. 9 illustrates a process that can be utilized for creating a plurality of libraries that can be utilized by the enterprise module A.

FIG. 10 illustrates the intersection library.

FIG. 11 illustrates an example of a configuration in which services can be divided into those that utilize platform independent code and those that use platform dependent code.

FIG. 12 illustrates a server architecture built utilizing the configuration as seen in FIG. 11.

### DETAILED DESCRIPTION

A method and apparatus for implementing a portable and open standards-based business application platform are disclosed. In the following description, for purposes of explanation, specific nomenclature is set forth to provide a thorough understanding of the present disclosure. However, it will be apparent to one skilled in the art that these specific details are not required in order to practice the method and apparatus disclosed herein. For example, although reference is made to the J2EE and .Net application platforms, the same techniques can easily be applied to other types of application platforms.

Certain computer application tasks require very large and complex computer software applications. For example, running an entire business operation requires a very large application (an “enterprise application”) that can handle many different tasks. Providing such large and complex enterprise software applications to a customer can be a great challenge to the enterprise software application developer.

Monolithic Application Executing at Customer Site

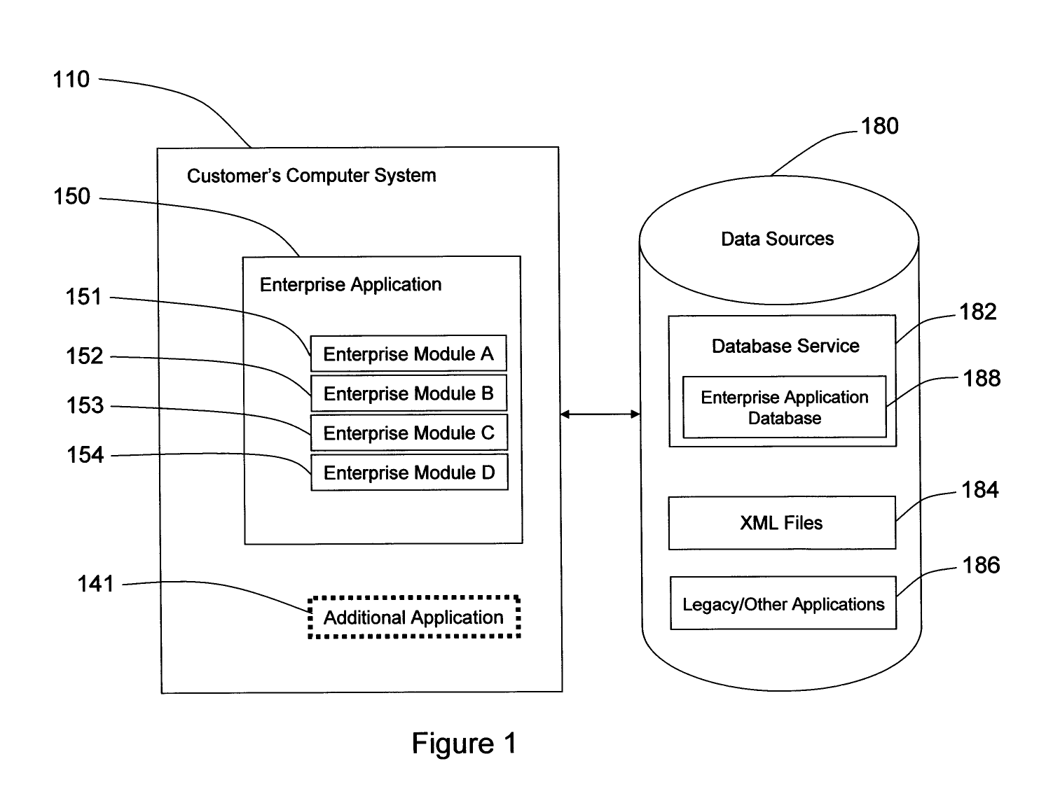

FIG. 1 illustrates infrastructure utilized in a large and complex application, such as an enterprise application. The infrastructure can be provided to the client by installing the enterprise application onto computers owned by the customer at the customer's premises. For instance, an enterprise application 150 can be installed to run on a customer's computer system 110. The enterprise application 150 may use data and/or services from the data sources 180, which include a database service 182, XML files 184, and legacy/other applications 186. Further, the database service 182 stores an enterprise application database 188.

The enterprise application 150 can be an expensive application, to purchase or lease, which utilizes significant computer resources. Further, installing and maintaining the enterprise software application 150 may require knowledgeable technicians. Thus, a smaller business might not want to use the large and complex enterprise application 150.

Even large corporations with significant computer resources and budgets may have difficulties with the large enterprise application. For example, a large corporation may already have a legacy software application that the corporation wishes to continue using. Thus, integrating the legacy software application with a new enterprise application 150 can be difficult and require very skilled application integrators.

The enterprise module 150 can include a variety of components, which form the building blocks of the enterprise module 150. An example of a component is a module, which is a collection of computer code that can be written to provide a service.

The enterprise application 150 may consist of many different individual modules. For example, as illustrated in FIG. 1, the enterprise module 150 can be composed of four individual enterprise modules: enterprise module A 151, enterprise module B 152, enterprise module C 153, and enterprise module D 154. A customer may need some of the enterprise modules while not needing others. For instance, a corporation may have use for the enterprise module A 151 and the enterprise module B 152, but may have no use for the enterprise module C and the enterprise module D. Further, the corporation may need an additional module that is not provided in the enterprise application 150. In those situations, the customer develops internally or purchases an additional application 141 that provides the features of the additional module. If an additional application 141 that provides the missing features is located, then the corporation must integrate that additional application 141 with the enterprise application 150. FIG. 1 illustrates the additional application 141 being integrated with the enterprise application 150. Such development is expensive because technical skills are needed to locate or develop the additional application 141 and then integrate the additional application 141 with the enterprise application 150. Accordingly, the corporation may not find the “one-size-fits-all” enterprise application 150 to be an optimal solution for its needs.

On-Line or Hosted Application Services

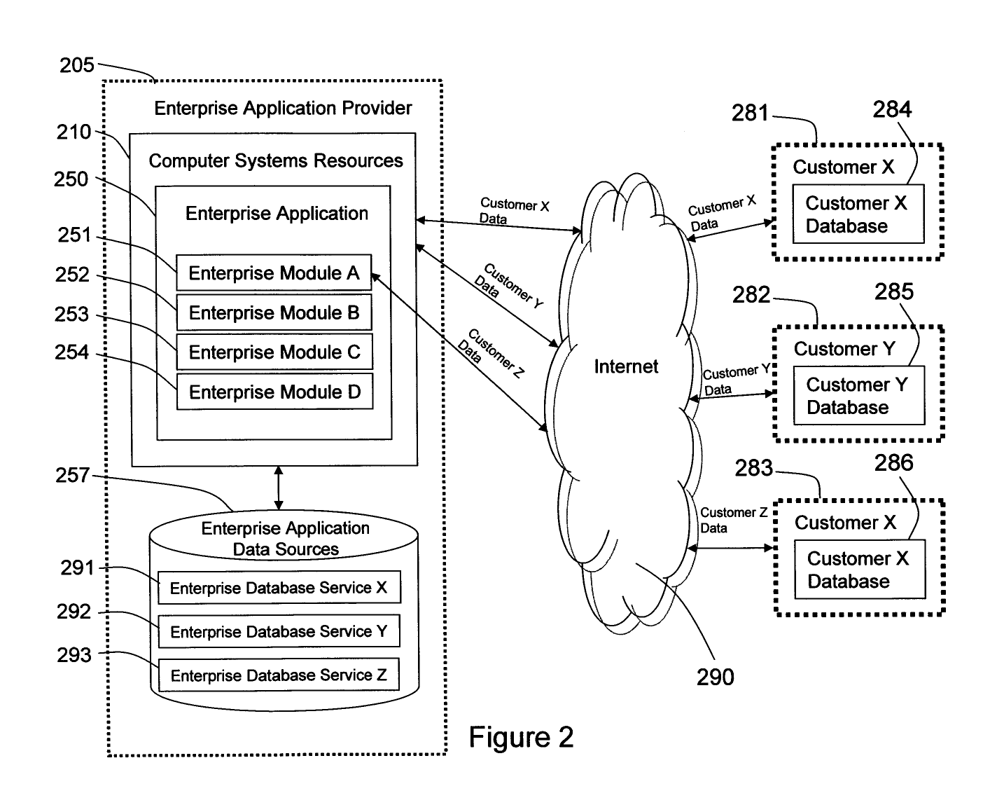

As an alternative to the monolithic enterprise software applications discussed above, enterprise application services can be provided to customers over the Internet. FIG. 2 illustrates an on-line or hosted infrastructure that can be utilized to provide an enterprise application 250 over the Internet 290. Specifically, an enterprise application provider 205 hosts the enterprise application 250 on a server and allows customers to access the server on-line. The server can be located at the enterprise application provider's facility. The enterprise application 250 mainly uses computer system resources 210 provided by the enterprise application provider 205. Customers such as customer X 281, customer Y 282, and customer Z 283 can access the enterprise application 250 over the Internet 290. Each of the customers can have a database. For instance, the customer X 281 may have a customer X database 284, the customer Y 282 may have a customer Y database 285, and the customer Z 283 may have a customer Z database 286. The enterprise application provider 205 keeps track of the different customer data using different database services in the enterprise application data sources 257, such as enterprise database service X 291 for customer X 281, enterprise database service Y 292 for customer Y 282, and enterprise database service Z 293 for customer Z 283.

Accordingly, the infrastructure of FIG. 2 allows small businesses to enjoy enterprise application services without needing to install and maintain a large enterprise application. Customers can access, and pay for, only portions of the enterprise application 250. For example, the customers X 281 and Y 282 send and receive data to and from all of the computer resources 210, thereby accessing the entire enterprise application 250 and all the enterprise modules, while customer Z 283 sends and receives data to and from only the enterprise module C 253, thereby accessing only enterprise application module C 253.

Enterprise Module Assembly of Enterprise Application Services

A customer that prioritizes having the enterprise application 150 on the customer's premises may purchase the “one-size-fits-all” enterprise application 150 of FIG. 1. Further, a customer that prioritizes maintaining low costs, e.g., a small business, may purchase individual modules of the enterprise application 250 of FIG. 2 to obtain limited enterprise application services at a lower cost than purchasing the entire “one-size-fits-all” enterprise application 150.

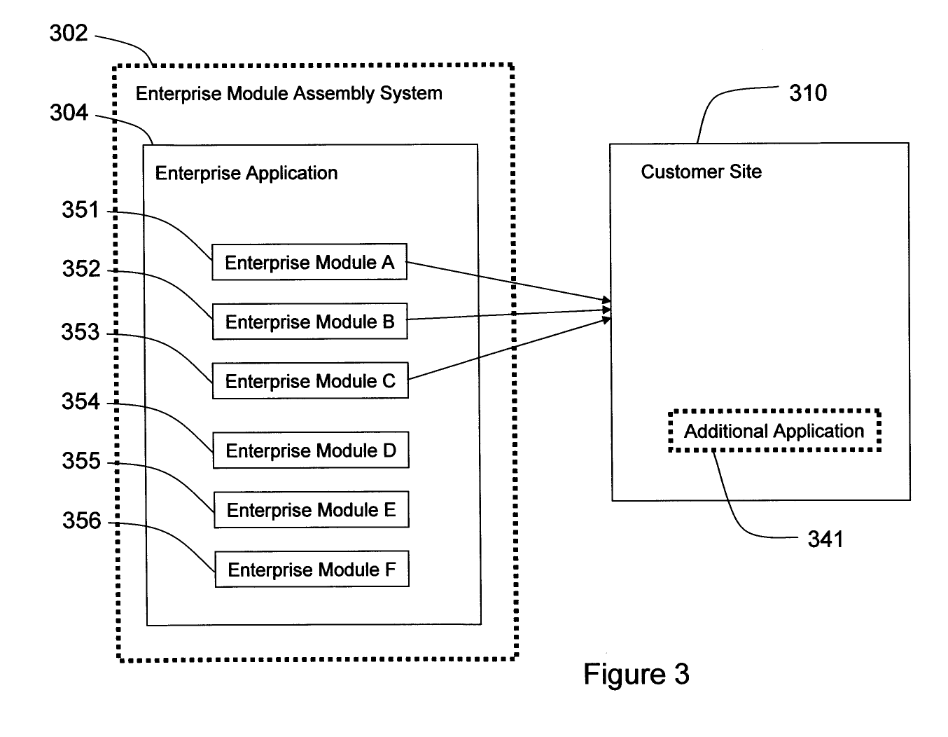

FIG. 3 illustrates an enterprise module assembly system 302 that allows a customer to both host the enterprise application software locally and only purchase the particular modules corresponding to the services that the customer actually needs. In addition, the enterprise module assembly system 302 allows a customer to integrate existing and/or new software on the customer's system with the enterprise modules that are purchased. Accordingly, the customer can assemble enterprise modules for particular services of an enterprise application in combination with the existing and/or new software on the customer's system.

In one embodiment, the enterprise module assembly system 302 breaks up an enterprise application 304 into individual enterprise modules. The enterprise application 304 can be a large complex computer application, e.g. an enterprise application or an even larger complex application program. The customer can then select the individual enterprise modules that the customer would like to utilize. Each of the enterprise modules can provide a different service. For instance, the enterprise application 304 may provide an enterprise module A 351 for purchasing source materials, an enterprise module B 352 for tracking production, an enterprise module C 353 for monitoring inventory levels, an enterprise module D 354 for monitoring quality, an enterprise module E 355 for setting pricing, and an enterprise module F 356 for maintaining customer relationships. The customer may then select which of these enterprise modules it would like to purchase. For instance, in FIG. 3, the customer has selected the enterprise module A, the enterprise module B, and the enterprise module C, but has not selected the enterprise module D, the enterprise module E, or the enterprise module F. The customer may not have selected the enterprise module D because the customer may already have existing software for monitoring quality. Further, the customer may not have selected the enterprise module E because, in the context of its business, the customer does not need any software for setting pricing. Finally, the customer may not have selected the enterprise module F because the customer plans on internally developing an additional application 341 for maintaining customer relationships.

The enterprise modules can be provided to the customer in a variety of ways. For instance, technicians can physically install the enterprise modules, which the customer has selected, at the customer site 310. Alternatively, the enterprise modules can be transmitted through a network, such as the Internet, to the customer site 310.

In another embodiment, the enterprise module assembly system 302 creates the enterprise modules as opposed to breaking up an existing enterprise application 304. In other words, the enterprise module assembly system 302 can create a collection of enterprise modules, each corresponding to a particular service, and allow a customer to select the enterprise modules that it would like to utilize.

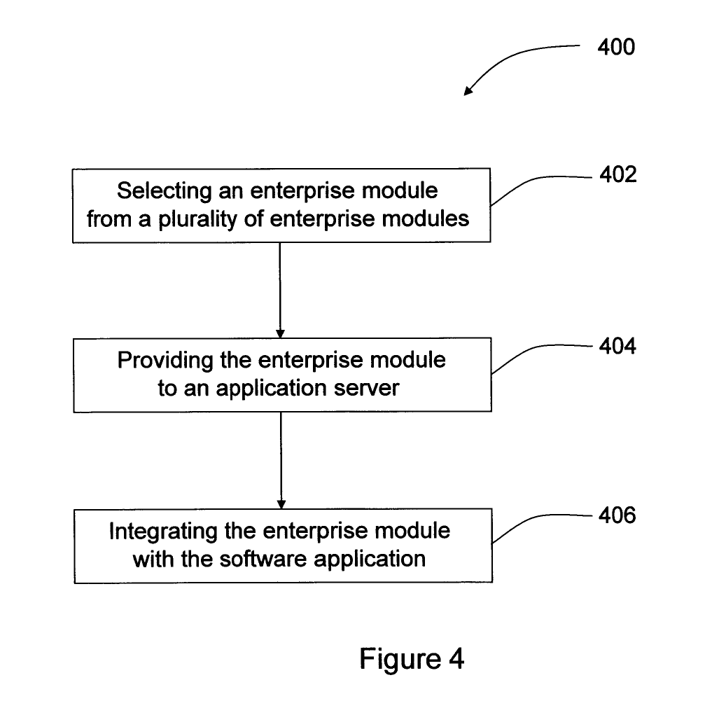

FIG. 4 illustrates a process 400 of enhancing a computer system. At a process block 402, the process 400 selects an enterprise module from a plurality of enterprise modules. The plurality of enterprise modules compose an enterprise application. Further, each of the enterprise modules includes enterprise object code generated from platform dependent source code and at least a subset of a plurality of platform dependent artifacts. As will be explained below, a developer can utilize the following to compose one of the enterprise modules: (1) high-level abstract languages to automatically generate platform dependent artifacts and (2) platform independent source code. The developer can essentially proceed with development in a portable manner because the developer can utilize a certain set of high-level abstract languages and platform independent source code irrespective of the customer's native software and hardware environment. Further, the enterprise module is developed according to an open standard because the enterprise object code is platform dependent to the specific customer's native software and hardware environment. At a process block 404, the enterprise module is provided to an application server. The application server stores a software application, which is generated from platform dependent object code. In addition, at a process block 406, the enterprise module is integrated with the software application.

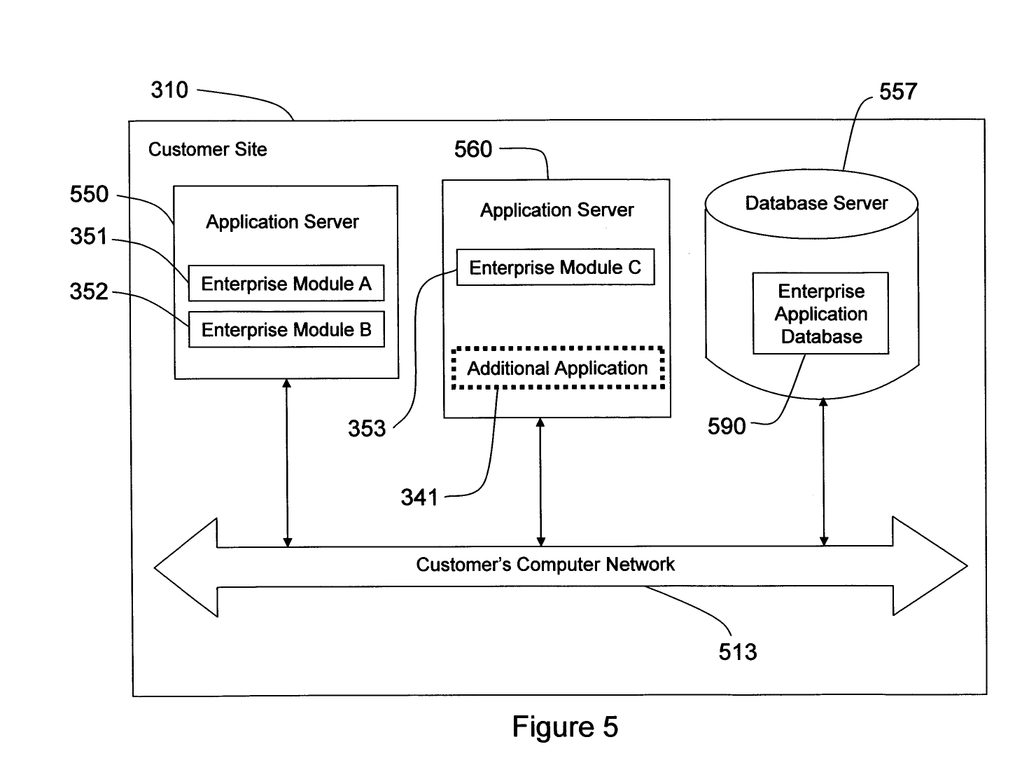

FIG. 5 illustrates an expanded view of the customer site 310, as seen in FIG. 3, for which the customer can implement the selected enterprise modules. For example, as seen in FIG. 3, the customer selects the enterprise module A, the enterprise module B, and the enterprise module C, but not the enterprise module D, the enterprise module E, or the enterprise module F. The customer may implement the selected enterprise modules on application servers, as illustrated in FIG. 5. For instance, the customer can host the enterprise module A 351 and the enterprise module B 352 on an application server 550. The application server 550 can then provide the services offered by the enterprise module A 351 and the enterprise module B 352. Further, the customer can host the enterprise module C 353 on a different application server 560. The other application server 560 may also host the additional application 341 that the customer internally developed, purchased, etc. In one embodiment, the additional application 341 includes platform dependent object code that is specific to the software and hardware at the customer site 310. While a developer composing the enterprise module C 353 was able to utilize high-level abstract languages and platform independent source code to prepare the code for the enterprise module C 353, the packaged enterprise module C 353 includes enterprise object code that is platform dependent specific to the software and hardware at the customer site 310. Since the enterprise module C 353 and the additional application 341 both include platform dependent object code compatible with the same platform, the enterprise module C 353 and the additional application 341 can be easily integrated with one another.

In addition, the customer site 310 has an enterprise application database 590 that is hosted on a database server 557. The enterprise application database 557 can store information related to each of the enterprise modules and the additional application 341 so that particular enterprise modules and/or the additional application 341 can be searched for. In addition, the customer site 310 has a computer network 513 through which the enterprise module A 351, the enterprise module B 352, the enterprise module C 353, the additional application 341, and the enterprise application database service 590 can all communicate with one another. For instance, although the enterprise module A 351 is stored on a different server than the additional application 341, the enterprise module A 351 and the additional application 341 can still communicate with one another.

Accordingly, a customer can utilize some or all of the individual enterprise modules from the enterprise application 304 (FIG. 3). The customer site 310, as illustrated in FIG. 5, can provide an open standards platform that has many tools and services for application development, application integration, and application management. Thus, a customer can easily create new application programs, e.g., the additional application 341, integrate the new application programs with the enterprise modules, and manage the enterprise modules and the new applications.

Composition of an Enterprise Module

A discussion shall now be provided regarding how an enterprise module is generated. For ease of discussion, the enterprise module A 351, as seen in FIG. 3, shall be utilized as an example of an enterprise module.

The enterprise module A 351 is constructed so that it (1) is portable and (2) utilizes an open standards platform. By being portable, the code utilized to create the enterprise module A 351 can compile and run on more than one application platform. For ease of discussion, examples shall be provided herein that utilize J2EE and .Net, which are well known platforms to one of ordinary skill in the art. However, other platforms known to one of ordinary skill in the art can easily be utilized. By being open, as discussed above, the enterprise object code included in the enterprise module A 351 is platform dependent so that the enterprise module A 351 can be easily integrated with other applications, e.g. the additional application 341 (FIG. 3), that have object code for the same platform that the customer utilizes.

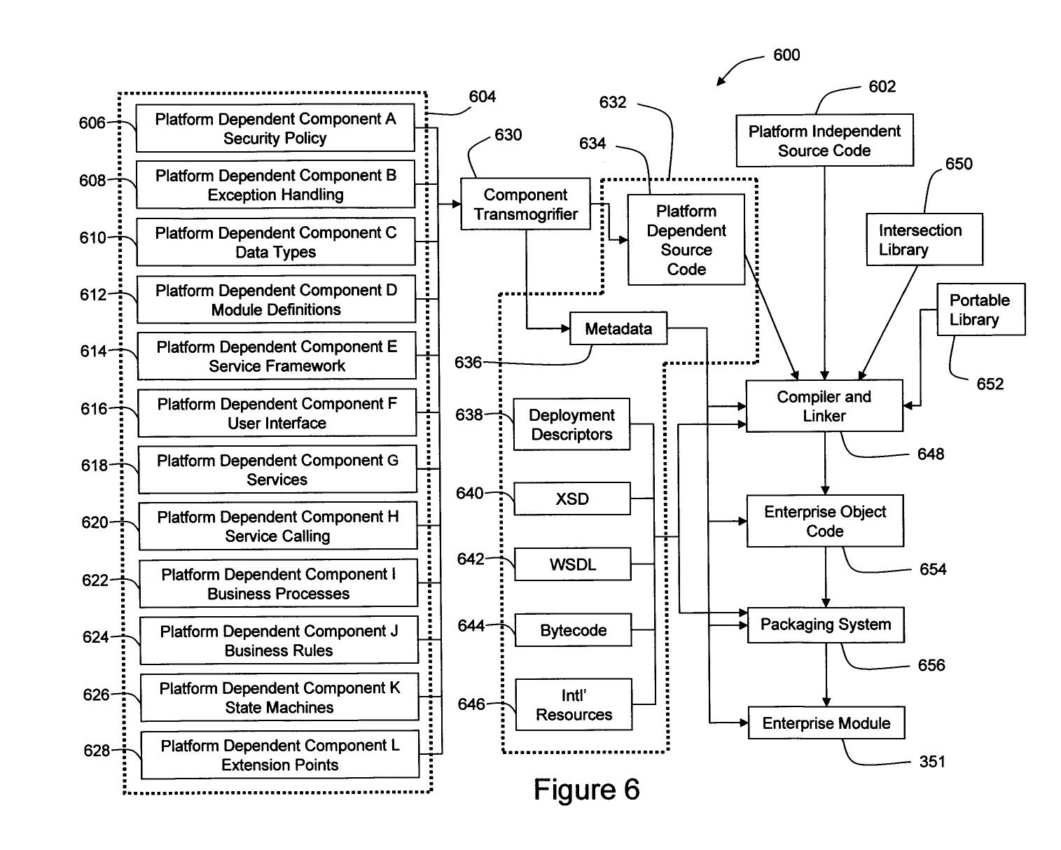

FIG. 6 illustrates an enterprise module construction system 600. The enterprise module construction system 600 can be utilized to construct the enterprise module A 351. The enterprise module A 351 is essentially constructed by combining platform independent source code 602 and a plurality of platform dependent components 604.

Initially, a developer determines what components of the enterprise module are platform independent and what components are platform dependent. In other words, in order for the enterprise module to eventually become native to a customer's system, some components of the enterprise module will require data specific to the individual customer's platform while other components of the enterprise module will not require data specific to the individual customer's platform.

The main algorithms utilized by the enterprise module A 351 are mostly not specific to the actual platform on which the enterprise module A 351 is being implemented. Accordingly, a large portion of these algorithms can be coded in platform independent source code 602. The platform independent source code 602 can be a subset of the syntax language of one or more platform independent languages. Accordingly, the platform independent source code 602 can be compiled on any of the compilers that support one of the platform independent languages utilized for the subsets. For instance, the platform independent source code 602 can be a subset of the syntax language for .Net and J2EE. If the function for concatenate is “concat” in both .Net and J2EE, then the subset includes the function “concat”. If the compiler supports .Net, then the use of the function “concat” is accepted by the compiler. Similarly, if the compiler supports J2EE, then the use of the function “concat” is also accepted by the compiler. An example of a subset of syntax language is a subset of the Java 1.1.4 computer language. The subset can be compiled on either a .Net or J2EE compiler.

However, some services are platform specific. For instance, the security policy for the enterprise module A 351 may vary significantly from one platform to another. The high-level abstract languages provide the developer with a way of coding the plurality of platform dependent components 604 in a portable manner. In other words, the developer does not have to actually code each of the platform dependent components 604 according to the individual customer's native platform. The developer can utilize the same high-level abstract language to code a particular platform dependent component 604 for different customers with different native platforms.

FIG. 6 illustrates platform dependent component A 606 for Security Policy, platform dependent component B 608 for Exception Handling, platform dependent component C 610 for Data Types, platform dependent component D 612 for Module Definitions, platform dependent component E 614 for Service Framework, platform dependent component F 616 for User Interface, platform dependent component G 618 for Services, platform dependent component H 620 for Service Calling, platform dependent component I 622 for Business Processes, platform dependent component J 624 for Business Rules, platform dependent component K 626 for State Machines, and platform dependent component L 628 for Extension Points. These are merely examples of different platform dependent components. A subset of the platform dependent components illustrated, a combination of the platform dependent components illustrated, or completely different platform dependent components may be utilized.

An example of a developer utilizing high-level abstract languages would involve the developer utilizing XML to code the platform dependent component A 606 for Security Policy and Java [Any other possible example language?] to code the platform dependent component B 608 for Exception Handling. In other words, the security policy on different customer systems may be significantly different, but the developer can utilize XML to code the platform dependent component A 606 for Security Policy customers with different platforms. Further, the developer can utilize Java to code the platform dependent component B 608 for Exception Handling for different customers. While a different high-level abstract language could potentially be utilized to code each platform dependent component 604, one high-level abstract language could also be used for all of the platform dependent components 604. In addition, a set of high-level abstract languages can be utilized so that each high-level abstract language may be utilized to code more than one of the platform dependent components 604. For example, XML and Java can be utilized for the plurality of platform dependent components 604 so that half of the platform dependent components 604 are coded in XML and half of the platform dependent components 604 are coded in Java. In an alternative embodiment, some of the platform dependent components illustrated in FIG. 6 may not be native to an individual customer's platform, and the developer may choose to classify those components as platform independent components.

The enterprise module construction system 600 provides the platform dependent components 604, coded in the high-level abstract language, to a component transmogrifier 630. Further, the component transmogrifier 630 has data regarding the platform specifics of the particular customer for which the enterprise module A 351 is being developed. Accordingly, the component transmogrifier 630 can automatically convert the code written by the developer for the platform dependent components 604 into platform dependent source code 634. In other words, the developer can utilize the same high-level abstract language to generate platform dependent source code for different platforms. The developer does not have to waste the resources that would be needed to become familiar with the computer languages utilized for each customer's platform.

The component transmogrifier 630 can output a plurality of platform dependent artifacts 632. For example, the platform dependent source code 634 is a platform dependent artifact. Metadata 636 is also an example of a platform dependent artifact. The metadata 636 can be any data associated with the enterprise module A 351. For instance, the metadata 636 can provide information for a graphical user interface, such as field names. Other examples of platform dependent artifacts 632 are deployment descriptors 638, XML Schema Definition 640 (“XSD”), Web Services Description Language 642 (“WSDL”), Bytecode 644, and International resources 646. The International resources include mainly localizable artifacts, such as localized strings, dialogs, screens, etc.

Further, the plurality of platform dependent artifacts 632, such as the platform dependent source code 634, are provided to the compiler and linker 648 so that the platform dependent source code 634 can be compiled and linked with the platform independent source code 602. As a result, enterprise object code 654 is generated.

In order to help facilitate software development, the module construction system 600 provides libraries of pre-constructed code that the developer can utilize when programming in the native platform computer languages. As the module construction system 600 is portable, a developer can access pre-constructed routines for any of the native platform computer languages that are utilized. Further, an intersection library 650 includes the set of routines that is commonly available in each of the native platform computer language libraries. An intersection occurs when the same name of a function appears through each of the native computer language libraries that are being utilized. For instance, a function to change the orientation of an object may be called “reorient” in both C# and Java. Even though the underlying code for the function “reorient” may be different in C# than in Java, a compiler that supports either C# or Java can be utilized to change the orientation of the object. However, if the name of the function in C# is “reorient” and the name of the function in Java is “rotate,” the two functions may be found in the portable library 652. Further, if there is a function in C# called “reorient,” but no function in Java, then a function is composed in Java and placed in the portable library 652. In one embodiment, the newly written function has the same name as the corresponding function in C#. In an alternative embodiment, the newly written function has a different name than the corresponding function in C#. The intersection library 650 and the portable library 652 are provided to the compiler and linker 648 so that the routines that are called from the developer's code can be found during the compilation and linkage phase.

The enterprise object code 654 is platform specific so that the enterprise object code 654 can be run on the customer's computer network 513 (FIG. 5). Further, as illustrated in FIG. 6, the enterprise object code 654 is provided to a packaging system 652, which adds additional information to the enterprise object code 654 to generate the enterprise module A 351. Accordingly, the enterprise module A 351 can now be utilized for the specific platform at the customer site 310 and can also be seamlessly integrated with other software at the customer site 310.

Some of the platform dependent artifacts 632 are provided after the compiling and linking phase. For instance, metadata may be provided to the compiler and linker 648, the enterprise object code 654, and the packaging system 656. The metadata can include information specific to the customer's platform. Accordingly, the metadata can help compile, link, and package the code for the enterprise module A 351 so that the enterprise module A 351 can run on the customer's native platform. Further, the metadata can be provided to the enterprise module A 351 at run time so that the enterprise module A 351 can execute according to customer specific information.

In addition, the deployment descriptors 638, XSD 640, WSDL 642, Bytecode 644, and Intl' resources 646 can also be added to the enterprise object code 654 and to the packaging system 656. These additional platform dependent artifacts may provide additional information and/or code that assists the enterprise module A 351.

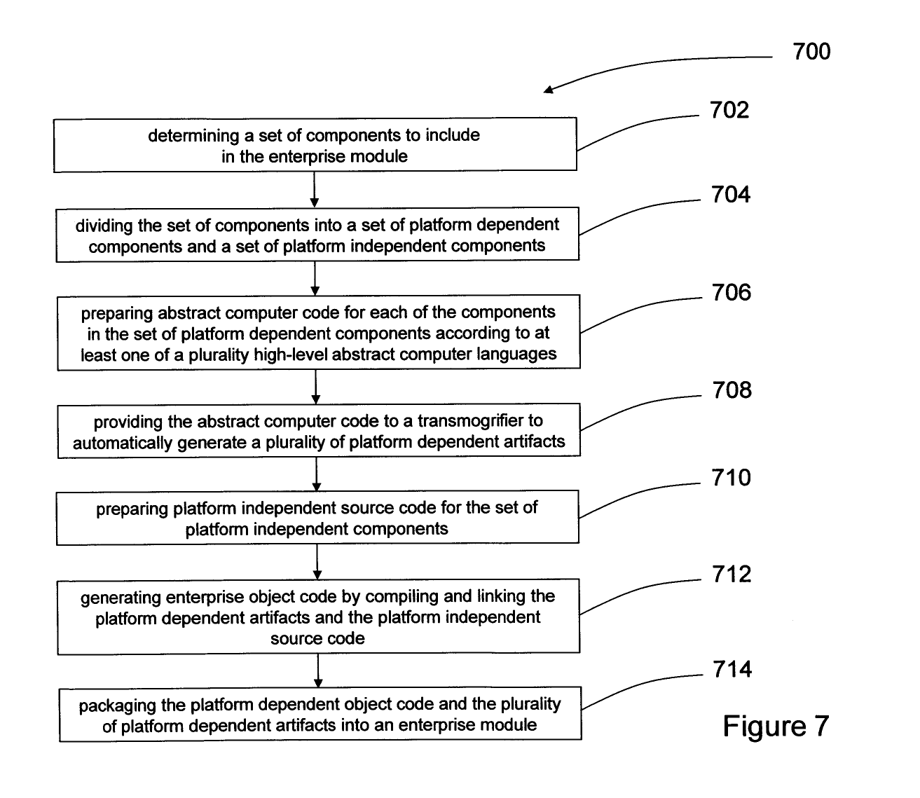

FIG. 7 illustrates a process 700 in which the enterprise module A 351 can be generated. At a process block 702, a set of components to be included in the enterprise module A 351 is determined. Further, at a process block 704, the set of components is divided into a set of platform dependent components and a set of platform independent components. In addition, at a process block 706, abstract computer code is prepared for each of the components in the set of platform dependent components according to at least one of a plurality of high-level abstract computer languages. At a process block 708, the abstract computer code is provided to a transmogrifier to automatically generate a plurality of platform dependent artifacts. The plurality of platform dependent artifacts can include platform dependent source code, metadata, deployment descriptors, XSD, WSDL, Bytecode, and Intl' resources. Further, at a process block 710, platform independent source code is prepared for the set of platform independent components. In addition, at a process block 712, enterprise object code is generated by compiling and linking the platform independent source code and at least a subset of a plurality of platform dependent artifacts. For instance, the subset of the plurality of platform dependent artifacts can include the platform dependent source code. Finally, at a process block 714, the platform dependent object code and the plurality of platform dependent artifacts are packaged into an enterprise module.

Libraries

The intersection library 650 includes code for native platform computer languages from Application Programming Interfaces (“APIs”) that have common syntax names across platforms where as the portable library 652 may include code from different platforms that have different syntax names or even code that is constructed to provide functionality for a platform that is missing from one platform yet present in another. Accordingly, the code with common syntax names is designated for the intersection library 650 and the code without common syntax names is designated for the portable library 652. As a result, any code that is missing for a particular platform in the portable library 652 can be composed.

Further, the platform independent source code 602 can be compiled and linked with the intersection library 650 and the portable library 652. In addition, the portable library 652 can be compiled with the platform independent source code 602.

A portability tree can be constructed to determine what code is portable and what code is non-portable. Routines for the portable code can be placed in the platform independent source code 602 while routines for the non-portable code can be placed in the portable library 652. Since a subset of platform independent languages is utilized for the platform independent code, only one routine for a particular task is placed into the platform independent source code 602. On the other hand, multiple routines for the same task may need to be placed into the portable library 652 to ensure that the same task can be performed by platform dependent code on any of the intended platforms at the customer site 310, as seen in FIG. 3.

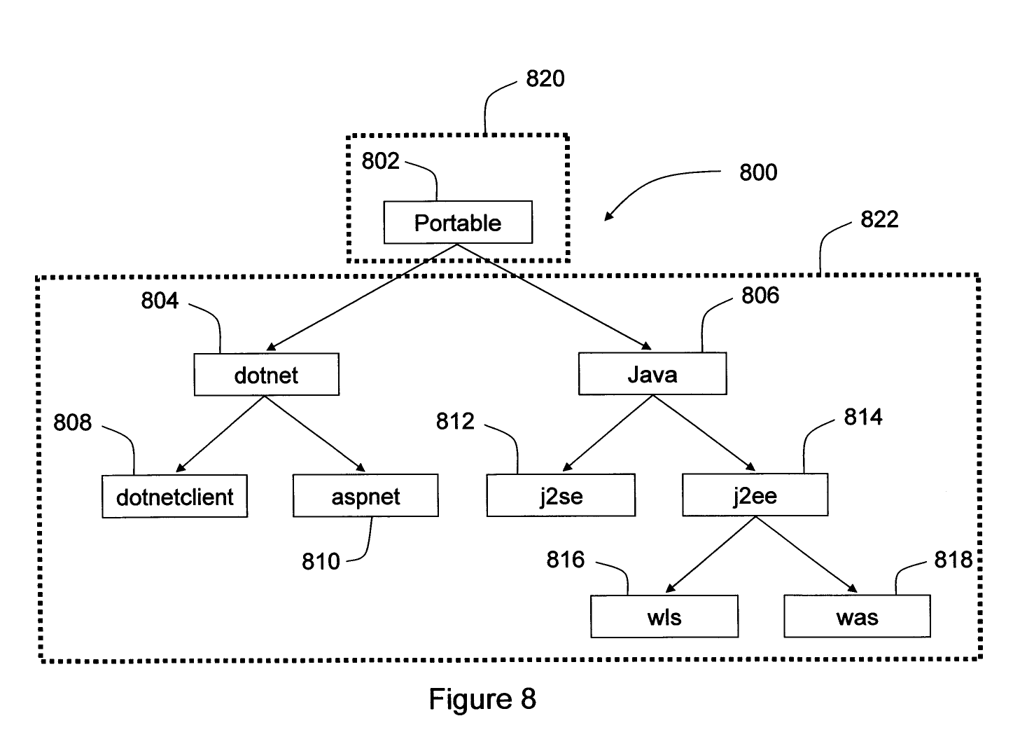

FIG. 8 illustrates a portability tree 800 that can be utilized to classify a set of code as portable and another set of code as non-portable. The portability tree 800, as seen in FIG. 8, depicts an example of a plurality of platforms and the relative level of portability for each of those platforms. A portable region 820 of the portability tree 800 indicates code that can run on a portable platform, thereby being platform independent. Further, a non-portable region 822 of the portability tree 800 indicates code that needs to run on a non-portable platform, thereby being capable of being compiled with code from the portable library 652. The leaflets of the portability tree 800 are placeholders for code in actual platforms where as any of the nodes above the leaflets are placeholders for code in virtual platforms. Through a downward propagation of the portability tree 800, the virtual platforms map to leaflets that hold code for actual platforms.

The root of the portability tree 800 is the most portable virtual platform where as the leaflets are the most specific and non-portable. For instance, if the code included in the enterprise module A 351 is written according to a portable node 802, the code can be utilized on any of the intended actual platforms for which the leaflets store code. At the next level of the portability tree 800, the code in the enterprise module A 351 is written in code for either the .Net 804 node or the Java 806 node. If the code is written for the .Net 804 node, then the code may not be compatible with the Java node 806, and vice versa. At the next level of the portability tree 800, the code in the enterprise module A 351 is written for the dotnet client node 808, the aspnet node 810, the j2se node 812, or the j2ee node 814. Code written in the dotnet client node 808 or the aspnet node 810 is compatible with the .Net node 804. Further, code written in the j2se node 812 or j2ee node 814 is compatible with Java 806. At the next level of the portability tree 800, the code in the enterprise module A 351 is written for the wls node 816 or the was node 818. Further, code written for the wls node 816 or the was node 818 is compatible with j2ee node 814. One of ordinary skill in the art will be familiar with these different platforms. Accordingly, the portability tree 800 can be utilized to classify the different pieces of code in the enterprise module A 351.

For instance, after performing a portability tree 800 analysis on the code of the enterprise module A 351, it may be determined that the enterprise module A 351 has a library and/or executable with code written and/or generated at the portable node 802, code written and/or generated for .Net 804, and code written and/or generated for the was node 818. With respect to the code for the portable node 802, the enterprise module A 351 can run this code on any platform. During a build, code can be generated for each of the platforms in the leaflet nodes. Accordingly, a downward propagation can be performed to build code for each of the platforms at a lower level. A downward propagation is intended to mean a traverse down to the leaflets of a position in the portability tree 800.

With respect to the code for .Net node 804, the enterprise module A 351 can run this code on any .Net platform. Further, a downward propagation can be utilized to generate code on any of the platforms that are leaflets from the .Net node 804, e.g., the dotnet client node 808 and the aspnet node 810. However, this code cannot be run on any of the leaflet nodes of the Java node 806, e.g., the j2se node 812 or the j2ee node 814, or any of the leaflets from the j2ee node 814, e.g., the wls node 816 or the was node 818. The code at the leaflet nodes needs to be compiled with the intersection library 650 and the portable library 652 to ensure that the platform specific routines needed by the platform dependent code is available.

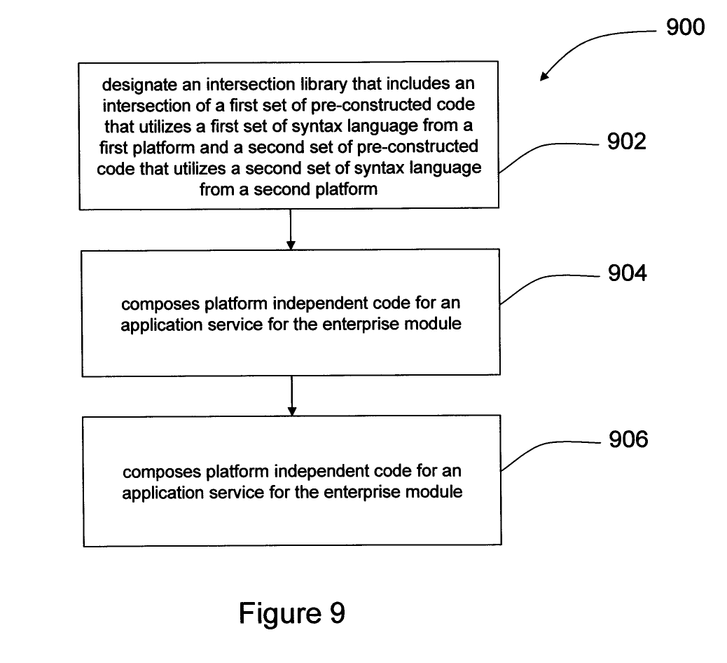

FIG. 9 illustrates a process 900 that can be utilized for designating a plurality of libraries that can be utilized by the enterprise module A 351. At a process block 902, the process 900 designates an intersection library that includes an intersection of a first set of pre-constructed code that utilizes a first set of syntax language from a first platform and a second set of pre-constructed code that utilizes a second set of syntax language from a second platform. Further, at a process block 904, the process 900 composes platform independent code for an application service for the enterprise module. The platform independent code is compiled and linked with the intersection library. In addition, at a process block 906, the process 900 designates a portable library that includes a third set of pre-constructed code that utilizes a third set of syntax language from a third platform and a fourth set of pre-constructed code that utilizes a fourth set of syntax language from a fourth platform. The third set of pre-constructed code and the fourth set of pre-constructed code composed in order to accomplish the same task, the portable library being compiled with platform dependent code for a core service for the enterprise module.

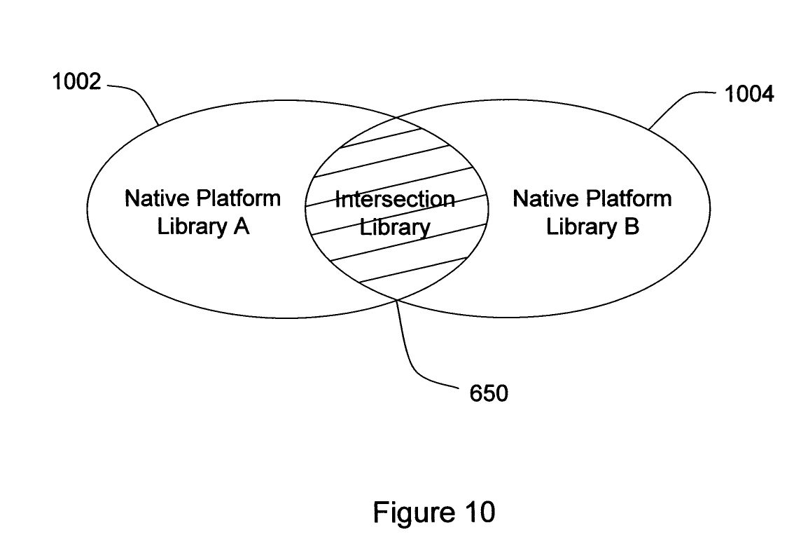

FIG. 10 illustrates the intersection library 650. Native platform library A 1002 has a first set of pre-constructed code that is included within the bounded area of platform independent library A 1002. Further, native platform library B 1004 has a second set of pre-constructed code that is included within the bounded area of platform independent library B 1004. The intersection library 650 includes the intersection of function signatures, e.g., method names and arguments, from the native platform library A 1002 and the native platform library B 1004.

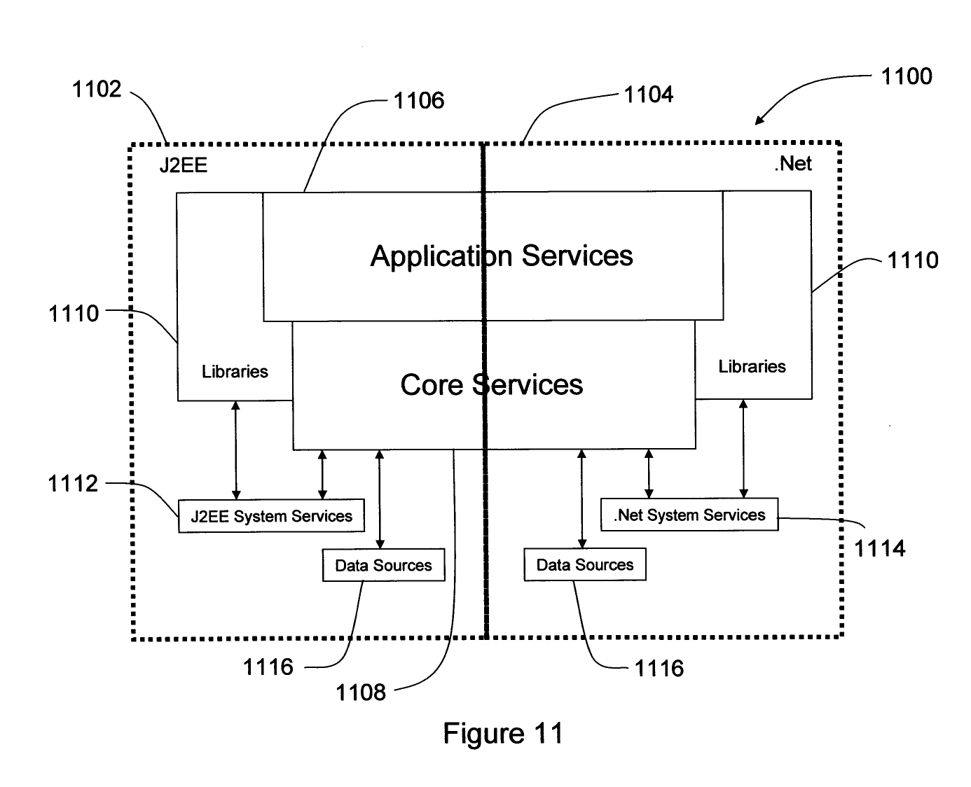

FIG. 11 illustrates an example of a configuration 1100 in which services can be divided into those that utilize platform independent code and those that use platform dependent code. For instance, code can be written and/or generated so that the code can run on either a J2EE platform 1102 or a .Net platform 1104. The code provides application services 1106 and core services 1108. The application services 1106 include the application logic for the enterprise module. Further, the core services 1108 include code for the infrastructure for the enterprise module. Examples of core services 1108 are Generic Data Services, Bus Comp Services, and Data Access Services. In one embodiment, the applications services 1106 are written and/or generated according to the subset of platform independent computer languages while the core services 1108 are written and/or generated according to platform dependent computer languages. Further, the libraries 1110 include the intersection library 650 and the portable library 652 so that the pre-constructed code is available for both the J2EE platform 1102 and the .Net platform 1104. For instance, the intersection library 650 can provide pre-constructed code for both the J2EE platform 1102 and the .Net platform 1104 because the intersection library 650 includes pre-constructed code that is part of a subset of code that can run on the J2EE platform 1102 and code that can run on the .Net platform 1104. In addition, the portable library 652 can provide pre-constructed code for both the J2EE platform 1102 and the .Net platform 1104 because the portable library 652 includes pre-constructed code that is platform specific for the J2EE platform 1102 and pre-constructed code that is platform specific for the .Net platform 1104. In other words, the intersection library 650 includes pre-constructed code to perform a task where as the portable library 652 includes multiple pieces of codes to accommodate different platforms, such as the J2EE platform 1102 and the .Net platform 1104. As a result, the enterprise module can be run on any of the intended platforms.

In addition, a set of data sources 1116 can be provided to the core services 1108. The same data sources can be provided to either the J2EE platform 1102 or the .Net platform 1104. However, specific system services are provided to each of the platforms. For instance, J2EE system services 1112 are provided to the core services 1108 and the libraries 1110. In one embodiment, the J2EE system services 1112 are provided to the portable library 652. Further, .Net system services 1114 are provided to the core services 1108 and the libraries 1110. In one embodiment, the .Net system services 1114 are provided to the portable library 652.

In another embodiment, the application services 1106 are not entirely platform independent. For instance, most of the application services 1106 may have code which is written and/or generated according to the syntax language for the subset of the code that can be run on the J2EE platform 1102 or the .Net platform 1104 while some of the application services 1106 may have multiple pieces of platform specific code for a particular service. One piece of code can be written and/or generated for the J2EE platform 1102 while another piece of code for the same particular service can be written and/or generated for the .Net platform 1104.

In yet another embodiment, most of the core services 1108 may have code which is written and/or generated according to the platform specific syntax language for the code that can be run on the J2EE platform 1102 or the platform specific language for the code that can be run on the .Net platform 1104 while some of the core services 1108 may be written and/or generated according to the syntax language for the subset of the code that can be run on the J2EE platform 1102 or the .Net platform 1104.

In another embodiment, a service invocation layer may exist between the layer for the application services 1106 and the core services 1108. The service invocation layer may have code which is written and/or generated according to the syntax language for the subset of the code that can be run on the J2EE platform 1102 or the .Net platform 1104. In addition, the service invocation layer may also have code which is written and/or generated according to the platform specific syntax language that can be run on the J2EE platform 1102 or code which is written and/or generated according to the platform specific syntax language that can be run on the .Net platform 1104.

Accordingly, the application services 1106 can run on both J2EE and .Net. The interfaces for these application services can be modeled as Web Services using WSDL and XML Schema. For instance, the interfaces can be prepared in WSDL and XML Schema, and can then be provided to the component transmogrifier 630, as seen in FIG. 6, to output platform dependent source code 634. The libraries 1110 can then be utilized to access the J2EE system services 1112 and the .Net system services 1114. For example, the J2EE system services 1112 and the .Net system services 1114 can include error handling, localizable strings, configuration, caching, state values and statistics, diagnostics and tracing, request context, service invocation, and XML and Web Services. A portion of the libraries 1110 may be exposed to Java classes while another portion of the libraries 1110 may be exposed to Web Services.

Some of the different system services that can be utilized for the J2EE system services 1112 and the .Net system services 1114 shall now be described. With respect to error handling, the error framework can be based on exceptions prepared in C# and Java. Exceptions are utilized to signal abnormal behavior and are not utilized to handle conditions expected as part of the normal flow.

In addition, with respect to diagnostics, a unified mechanism to monitoring the health of the system is a requirement not only for application developers, but for core developers as well. A rich functional API is provided that interfaces seamlessly with the native platform's facilities and that will not incur on any significant overhead. The rich functional API will consist of a series of APIs to log messages (including error logging), and a mechanism to profile request processing. These facilities integrate with the diagnostic tools native to the platform where the code is executing.

Further, localizable strings can be defined as key value pairs. Strings can be grouped by enterprise module and are identified by the unique key for the string. The unique key can be a symbolic name that includes a component code and a symbolic name. Further, the localizable strings can be defined in XML files. Each enterprise module in a source tree can have a “strings” directory which can contain all the localized string files for the given enterprise module.

In one embodiment, caching functionality is provided on top of the native caching mechanisms. Accordingly, the native caching mechanisms are taken into account when utilizing the interfaces described above.

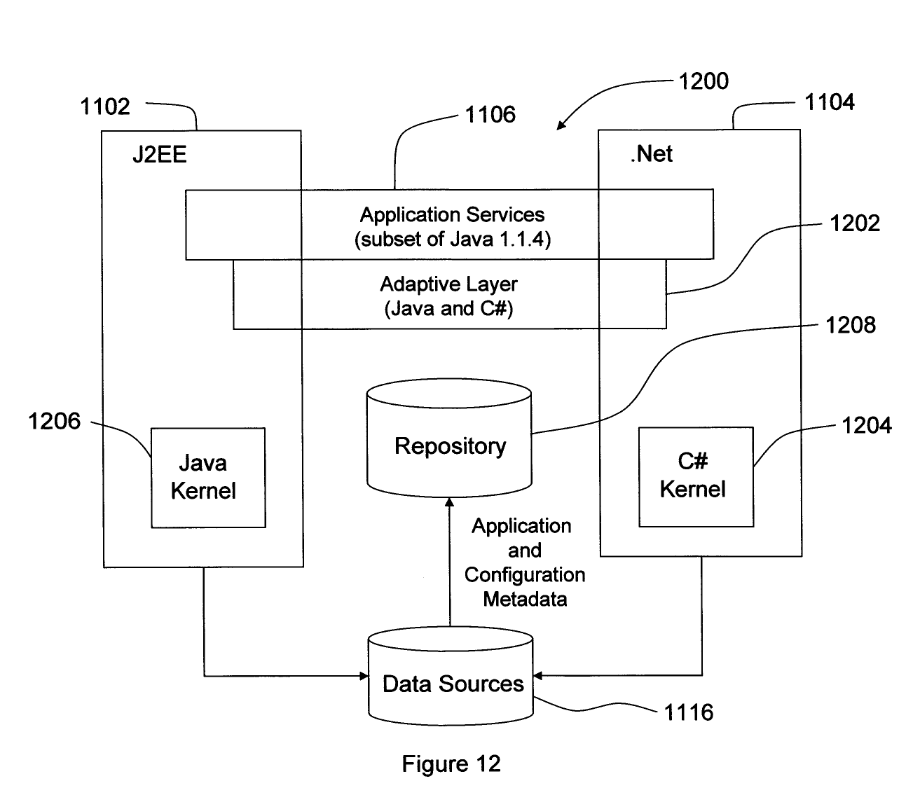

FIG. 12 illustrates a server architecture 1200 built utilizing the configuration 1100 as seen in FIG. 11. The server architecture 1200 implements the application services 1106, which can be run on both the J2EE platform 1102 and the Java platform 1104 because the applications services 1106 utilize a subset of Java 1.1.4. Further, an adaptive layer 1202 utilizes Java and C#. Accordingly, the adaptive layer 1202 has multiple sets of code to accomplish the same task. Further, a C# kernel 1204 and a Java kernel 1206 are each written and/or generated. The C# kernel 1204 can be utilized with the Net platform 1104, and the java kernel 1206 can be utilized with the J2EE platform 1102. Data from the J2EE platform 1102 and the Net platform 1104 can be provided to the data sources 1116 and vice versa. Further, application and configuration metadata are sent from the data sources 1116 to a repository 1208.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the following claims. The specification and drawings are, accordingly, to be regarded in an illustrative sense rather than a restrictive sense.

1. A method comprising:
designating an intersection library that includes an intersection of a first set of pre-constructed code that utilizes a first set of syntax language from a first platform and a second set of pre-constructed code that utilizes a second set of syntax language from a second platform;
composing platform independent code for an application service for an enterprise module, the platform independent code being compiled and linked with the intersection library; and
designating a portable library that includes a third set of pre-constructed code that utilizes a third set of syntax language from a third platform and a fourth set of pre-constructed code that utilizes a fourth set of syntax language from a fourth platform, the third set of pre-constructed code and the fourth set of pre-constructed code composed in order to accomplish the same task, the portable library being compiled with platform dependent code for a core service for the enterprise module.

2. The method of claim 1, wherein the platform independent code includes a subset of a first set of syntax language from the first platform and a second set of syntax language from the second platform.

3. The method of claim 1, wherein the first platform is .Net.

4. The method of claim 1, wherein the second platform is J2EE.

5. The method of claim 1, wherein the intersection is positioned within a portable region of a portability tree.

6. The method of claim 1, wherein the third set of pre-constructed code is positioned within a non-portable region of a portability tree.

7. The method of claim 1, wherein the fourth set of pre-constructed code is positioned within a non-portable region of a portability tree.

8. A machine readable medium having stored thereon a set of instructions which when executed perform a method comprising:
designating an intersection library that includes an intersection of a first set of pre-constructed code that utilizes a first set of syntax language from a first platform and a second set of pre-constructed code that utilizes a second set of syntax language from a second platform;
composing platform independent code for an application service for an enterprise module, the platform independent code being compiled and linked with the intersection library; and
designating a portable library that includes a third set of pre-constructed code that utilizes the first set of syntax language from the first platform and a fourth set of pre-constructed code that utilizes the second set of syntax language from the second platform, the third set of pre-constructed code and the fourth set of pre-constructed code composed in order to accomplish the same task, the portable library being compiled with platform dependent code for a core service for the enterprise module.

9. The machine readable medium of claim 8, wherein the platform independent code includes a subset of a first set of syntax language from the first platform and a second set of syntax language from the second platform.

10. The machine readable medium of claim 8, wherein the first platform is .Net.

11. The machine readable medium of claim 8, wherein the second platform is J2EE.

12. The machine readable medium of claim 8, wherein the intersection is positioned within a portable region of a portability tree.

13. The machine readable medium of claim 8, wherein the third set of pre-constructed code is positioned within a non-portable region of a portability tree.

14. The machine readable medium of claim 8, wherein the fourth set of pre-constructed code is positioned within a non-portable region of a portability tree.

15. A system comprising:
a unit that creates a portability tree that includes a portable region and a non-portable region;
a unit that classifies a plurality of platforms and virtual platforms according to positions in the portable region and the non-portable region of the portability tree;
a unit that designates an intersection library that includes an intersection of a first set of pre-constructed code that utilizes a first set of syntax language from a first platform and a second set of pre-constructed code that utilizes a second set of syntax language from a second platform;
a unit that composes platform independent code for an application service for an enterprise module, the platform independent code being compiled and linked with the intersection library; and
a unit that designates a portable library that includes a third set of pre-constructed code that utilizes a third set of syntax language from a third platform and a fourth set of pre-constructed code that utilizes a fourth set of syntax language from a fourth platform, the third set of pre-constructed code and the fourth set of pre-constructed code composed in order to accomplish the same task, the portable library being compiled with platform dependent code for a core service for the enterprise module, the third platform and the fourth platform being positioned in the non-portable region of the portability tree.

16. The system of claim 15, wherein the platform independent code includes a subset of a first set of syntax language from the first platform and a second set of syntax language from the second platform.

17. The system of claim 15, wherein the first platform is .Net.

18. The system of claim 15, wherein the second platform is J2EE.

19. The system of claim 15, wherein the root of the portability tree is within the portable region.

20. The system of claim 15, wherein leaflets of the portability tree are in the non-portable region.
